(19) United States
(12) Patent Application Publication
(10) Pub. No.: US 2014/0293049 A1
(43) Pub. Date: Oct. 2, 2014

(54) Fire Detection and Surveillance System

(71) Applicant: Shenzhen Guangan Fire-Fighting & Decoration Engineering Co., Ltd., Shenzhen (CN)

(72) Inventors: Shaobin LI, Shenzhen (CN); Wenguang LUO, Shenzhen (CN); Wenhui HUA, Shenzhen (CN)

(73) Assignee: Shenzhen Guangan Fire-Fighting & Decoration Engineering Co., Ltd., Shenzhen (CN)

(21) Appl. No.: 14/163,399

(22) Filed: Jan. 24, 2014

(30) Foreign Application Priority Data
Apr. 1, 2013 (CN) 201310111288.5

(51) Int. Cl. G08B 17/12

(52) U.S. Cl. CPC G08B 17/125
USPC 348/143

(57) ABSTRACT

A fire detection and surveillance system includes a fire detector, a main control unit electrically connecting to the fire detector, and a surveillance system electrically connecting to the main control unit. When the fire detector detects occurrence of fire in a predetermined area, the fire detector is arranged to send a corresponding signal to the main control unit, and trigger the surveillance system to capture a visual video of the predetermined area.

### CROSS REFERENCE OF RELATED APPLICATION

This is a non-provisional application that claims the benefit of priority under 35 U.S.C. §119 to a foreign application number 201310111288.5, filing date Apr. 01, 2013 in China. The contents of this specification are incorporated herein by reference.

### BACKGROUND OF THE PRESENT INVENTION

1. Field of Invention

The present invention relates to a fire detection and surveillance system, and more particularly to a fire detection and surveillance system which is capable of capturing a video at a location where fire occurs.

2. Description of Related Arts

Many cities around the world have been developing very rapidly, and they may have very high population and require a large number of high-rise buildings and large-scale industrialization. Because of these developments, their need for stable and reliable power supply is increasing very rapidly. These large-scale developments and industrialization become the source of potential fire hazard. At the same time, however, the awareness of fire safety among people in these cities is decreasing. Conflagration can cause a large number of deaths and injuries.

When fire occurs, the single most important task is to accurately ascertain the source of the fire and combat the fire so as to prevent it from rapidly spreading to other areas. Conventional fire detectors have been developed and widely utilized to detect certain indicators of fire. For example, smoke detectors have been developed to detect smoke which is a major indicator of fire. Other detectors include flame detectors, heat detectors or fire gas detectors.

On the other hand, most commercial or residential buildings have installed surveillance system for security purpose. For example, a predetermined number of surveillance cameras may be installed on public areas of a commercial building so that a security guard may monitor the corresponding area of the building.

A major disadvantage of conventional fire detection system and surveillance system is that they work independently and do not work as a system to not only effectively detect fire, but also promptly capture the image or video in the area where the fire occurs. This is particularly important because the availability of the video of the fire scene may help firefighters to combat an ongoing fire, and may help the relevant authorities to gather evidence and investigate the cause of the fire.

### SUMMARY OF THE PRESENT INVENTION

An objective of the present invention is to provide a fire detection and surveillance system which is capable of capturing video at a location where fire occurs.

Another objective of the present invention is to provide a fire detection and surveillance system which comprises a fire detector and a surveillance system working together for detecting predetermined indicators of fire, and for capturing the video of a predetermined area when the fire detector is triggered.

Another objective of the present invention is to provide a fire detection and surveillance system which can be used in a wide variety of situations, and can be centrally controlled to achieve the best co-ordination and co-operation between all the components of the present invention.

Another objective of the present invention is to provide a fire detection and surveillance system which can be connected to governmental agencies so as to promptly alert relevant government agencies, such as the fire department, for providing prompt assistance to combat an ongoing fire.

In one aspect of the present invention, it provides a fire detection and surveillance system, comprising:

a fire detector;

a main control unit electrically connecting to the fire detector; and

a surveillance system electrically connecting to the main control unit, wherein when the fire detector detects occurrence of fire in a predetermined area, the fire detector is arranged to send a corresponding signal to the main control unit, and trigger the surveillance system to capture a visual video of the predetermined area.

In another aspect of the present invention, it provides a fire detection and surveillance system, comprising:

a plurality of fire detectors;

a main control unit electrically connecting to the fire detectors; and

a surveillance system, which comprises:

a plurality of video capturing devices; and

a plurality of surveillance control devices electrically connecting to the main control unit and the video capturing devices respectively, wherein each of the surveillance control devices is arranged to process and store the video captured by the corresponding video capturing device, wherein when at least one of the fire detectors detects occurrence of fire in a predetermined area, the fire detector is arranged to send a corresponding signal to the main control unit, and trigger the corresponding video capturing devices to capture a visual video of the predetermined area.

### BRIEF DESCRIPTION OF THE DRAWINGS

FIG. 1 is a block diagram of a fire detection and surveillance system according to a preferred embodiment of the present invention.

FIG. 2 is a schematic diagram of the fire detection and surveillance system according to the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

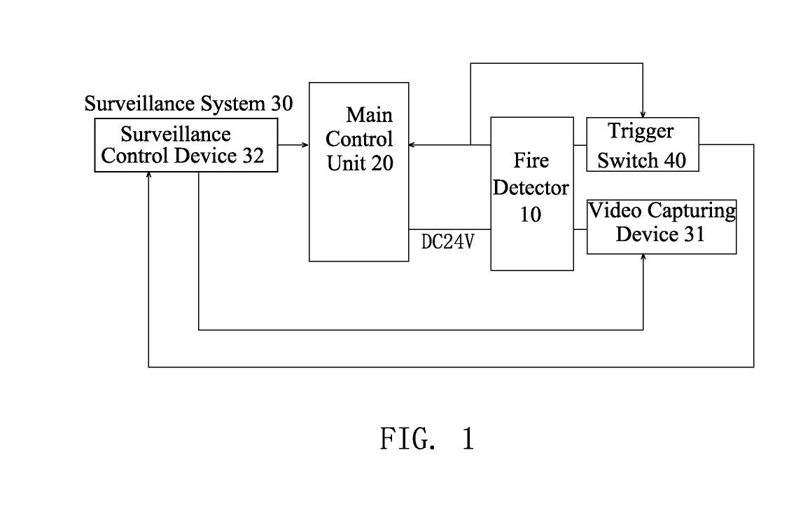

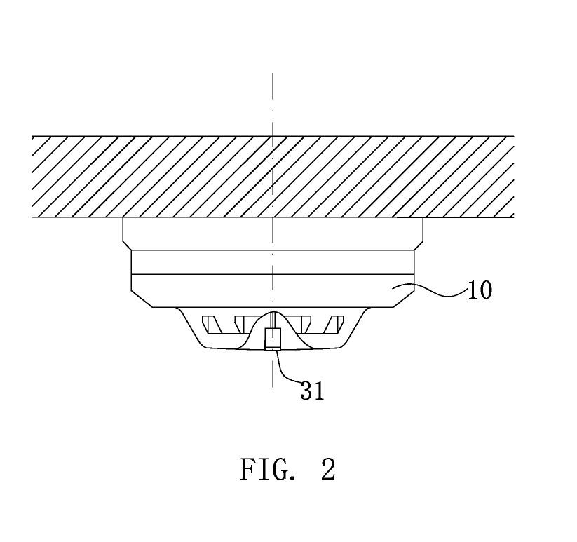

Referring to FIG. 1 to FIG. 2 of the drawings, a fire detection and surveillance system according to a preferred embodiment of the present invention is illustrated. Broadly, the fire detection and surveillance system comprises at least one fire detector 10, a main control unit 20 electrically connecting to the fire detector 10, and a surveillance system 30 electrically connecting to the main control unit 20, wherein when the fire detector 10 detects occurrence of fire in a predetermined area, the fire detector 10 is arranged to send a corresponding signal to the main control unit 20, and trigger the surveillance system 30 to capture a visual video of the predetermined area.

According to the preferred embodiment of the present invention, the fire detector 10 is arranged to detect a predetermined indicator of fire. For example, the fire detector 10 may be a smoke detector, a flame detector (e.g. a ultraviolet flame detector or an infrared flame detector), a fire gas detector, a radiation detector, a heat detector (e.g. a fixed temperature heat detector or a rate-of-rise heat detector), an ionization smoke detector, photoelectric smoke detector, or an air-sampling smoke detector. The fire detection and surveillance system may comprise a plurality of the fire detectors 10 for detecting one or more indicators of fire. For example, they can all be smoke detectors. Alternatively, some of the fire detectors 10 may be smoke detectors while others are heat detectors.

The main control unit 20 is electrically connected to the fire detectors 10, and is installed in a predetermined position of a building in which the fire detection and surveillance system is implemented. The main control unit 20 is arranged to coordinate and control the operation of the fire detectors 10 and the surveillance system 30 so as to assist in monitoring the fire scene and combating fire. Furthermore, the main control unit 20 is electrically connect to the fire detectors 10 for supplying power to them. An exemplary voltage supplied to each fire detector 10 is DC 24V.

When a predetermined fire indicator (such as smoke, flame, temperature etc.) is detected by the corresponding fire detector 10, the fire detector 10 is triggered to send an electrical signal to the main control unit 20. The main control unit 20 may be arranged to record the location of the fire, trigger an existing automated fire alarm system in the building, and alert the fire department.

The surveillance system 30 comprises a plurality of video capturing devices 31, and a plurality of surveillance control devices 32 electrically connecting to the main control unit 20 and the video capturing devices 31. Each of the surveillance control devices 32 is arranged to process and store the video captured by the corresponding video capturing devices 31.

It is worth mentioning that electrical connection between the surveillance system 30 and the main control unit 20 can be accomplished by conventional wired connection such as through phone cables, optical fibers, or by wireless connection such as through infrared radiation, microwaves etc. Thus, when fire occurs, the relevant persons, such as firefighters, security staff, or other persons may be able to monitor the fire scene through the main control unit 20 and the surveillance system 30. Moreover, the relevant authorities may also retrieve the video of the fire scene to investigate the possible cause of the fire. Security measures may be implemented on the main control unit 20 so as to restrict access of the video to authorized persons.

Referring to FIG. 1 of the drawings, the fire detectors 10 may be installed on every floor or every room of a building. Each of the fire detectors 10 is electrically connected to the main control unit 20 which is centrally installed on a predetermined location of the building, such as a control room of the building. Each of the fire detectors 10 has a unique address code programmed on the main control unit 20 so that when any one of the fire detectors 10 is activated, the main control unit 20 may be able to identify which of the fire detector(s) 10 is triggered, and the location of the relevant fire detector(s) 10.

Referring to FIG. 2 of the drawings, each of the video capturing devices 31 is mounted at a position near the corresponding fire detector 10 so that each of the video capturing devices 31 is capable of capturing the image or video of the area in the vicinity of the corresponding fire detector 10. This area is likely to be where the fire originates. The video capturing devices 31 are electrically connected to the surveillance control device 32.

According to the preferred embodiment of the present invention, each of the video capturing devices 31 is mounted on a bottom portion of the corresponding fire detector 10. When the fire detector 10 is triggered by one or more predetermined indicators of fire, the corresponding video capturing device 31 is also triggered to capture a video of the area in front of the fire detector 10.

The surveillance system 30 further comprises a plurality of trigger switches 40 electrically connecting between each of the surveillance control devices 32 and the corresponding fire detector 10. According to the preferred embodiment of the present invention, when the fire detector 10 is triggered by a predetermined indicator of fire and sends a corresponding signal to the main control unit 20, the corresponding trigger switch 40 is also triggered to switch on the corresponding surveillance control devices 32 for activating the video capturing device 31 which is electrically connecting to the surveillance control device 32. Each of the trigger switches 40 may be embodied as a relay. When the fire detector 10 is not triggered, the relay cuts off the electricity supplied to the corresponding surveillance control device 32. When the fire detector 10 is triggered and sends an electrical signal to the main control unit 20, the electrical signal triggers the trigger switch 40 which allows electricity to be supplied to the surveillance control device 32. The surveillance control device 32 is then arranged to turn on the corresponding video capturing device 31 for capturing the video of the area in the vicinity of the corresponding fire detector 10.

The operation of the present invention is as follows: when fire occurs, one or more indicators of fire may trigger the fire detectors 10 which are arranged to send electrical signals to the main control unit 20. These electrical signals trigger the trigger switches 40 for supplying electricity to the surveillance control device 32 which drives the corresponding video capturing device 31 to operate. The video capturing device 31 is then arranged to capture the video of the fire scene.

The present invention, while illustrated and described in terms of a preferred embodiment and several alternatives, is not limited to the particular description contained in this specification. Additional alternatives or equivalent components could also be used to practice the present invention.

What is claimed is:

1. A fire detection and surveillance system, comprising:
a fire detector;
a main control unit electrically connecting to said fire detector; and
a surveillance system electrically connecting to said main control unit, wherein when said fire detector detects occurrence of fire in a predetermined area, said fire detector is arranged to send a corresponding signal to said main control unit, and trigger said surveillance system to capture a visual video of said predetermined area.

2. The fire detection and surveillance system, as recited in claim 1, wherein said surveillance system comprises at least one video capturing device, and at least one surveillance control device electrically connecting to said main control unit and said video capturing device, wherein said surveillance control device is arranged to process and store said video captured by said video capturing device.

3. The fire detection and surveillance system, as recited in claim 2, wherein said surveillance system further comprises at least one trigger switch electrically connecting between said surveillance control device and said fire detector, in such a manner that when said fire detector is triggered and sends a corresponding signal to said main control unit, said trigger switch is also triggered to switch on said corresponding surveillance control device for activating said video capturing device which is electrically connecting to said surveillance control device.

4. The fire detection and surveillance system, as recited in claim 2, wherein said video capturing device is mounted at a bottom portion of said fire detector, such that when said fire detector is triggered, said video capturing device is also triggered.

5. The fire detection and surveillance system, as recited in claim 3, wherein said video capturing device is mounted at a bottom portion of said fire detector, such that when said fire detector is triggered, said video capturing device is also triggered.

6. The fire detection and surveillance system, as recited in claim 2, wherein said trigger switch is a relay.

7. The fire detection and surveillance system, as recited in claim 3, wherein said trigger switch is a relay.

8. The fire detection and surveillance system, as recited in claim 1, wherein said fire detector has a unique address code programmed on said main control unit.

9. The fire detection and surveillance system, as recited in claim 3, wherein said fire detector has a unique address code programmed on said main control unit.

10. The fire detection and surveillance system, as recited in claim 7, wherein said fire detector has a unique address code programmed on said main control unit.

11. The fire detection and surveillance system, as recited in claim 1, wherein said fire detector is at least one of a smoke detector, a flame detector, a fire gas detector, a radiation detector and a heat detector.

12. The fire detection and surveillance system, as recited in claim 5, wherein said fire detector is at least one of a smoke detector, a flame detector, a fire gas detector, a radiation detector and a heat detector.

13. The fire detection and surveillance system, as recited in claim 10, wherein said fire detector is at least one of a smoke detector, a flame detector, a fire gas detector, a radiation detector and a heat detector.

14. The fire detection and surveillance system, as recited in claim 11, wherein said smoke detector comprises at least one of an ionization smoke detector, a photoelectric smoke detector, and an air-sampling smoke detector.

15. The fire detection and surveillance system, as recited in claim 13, wherein said smoke detector comprises at least one of an ionization smoke detector, a photoelectric smoke detector, and an air-sampling smoke detector.

16. The fire detection and surveillance system, as recited in claim 11, wherein said heat detector comprises at least one of a fixed temperature heat detector and a rate-of-rise heat detector.

17. The fire detection and surveillance system, as recited in claim 13, wherein said heat detector comprises at least one of a fixed temperature heat detector and a rate-of-rise heat detector.

18. The fire detection and surveillance system, as recited in claim 11, wherein said flame detector comprises at least one of an ultraviolet flame detector and an infrared flame detector.

19. The fire detection and surveillance system, as recited in claim 13, wherein said flame detector comprises at least one of an ultraviolet flame detector and an infrared flame detector.

20. A fire detection and surveillance system, comprising:
a plurality of fire detectors;
a main control unit electrically connecting to said fire detectors; and
a surveillance system, which comprises:
a plurality of video capturing devices; and
a plurality of surveillance control devices electrically connecting to said main control unit and said video capturing devices respectively, wherein each of said surveillance control devices is arranged to process and store said video captured by said corresponding video capturing device, wherein when at least one of said fire detectors detects occurrence of fire in a predetermined area, said fire detector is arranged to send a corresponding signal to said main control unit, and trigger said corresponding video capturing devices to capture a visual video of said predetermined area.
